(19) United States
(12) Patent Application Publication
(10) Pub. No.: US 2025/0122002 A1
(43) Pub. Date: Apr. 17, 2025

(54) CONTAINER STRUCTURE AND FLUID TRANSFER DEVICE INCLUDING THE SAME

(71) Applicant: Pukyong National University Industry-University Cooperation Foundation, Busan (KR)

(72) Inventor: Joong Ho SHIN, Busan (KR)

(21) Appl. No.: 18/913,344

(22) Filed: Oct. 11, 2024

(30) Foreign Application Priority Data
Oct. 12, 2023 (KR) 10-2023-0135920

(51) Int. Cl. B65D 83/00; B65D 51/00

(52) U.S. Cl. CPC B65D 83/7711; B65D 51/002

(57) ABSTRACT

A container structure and a fluid transfer device including the same are disclosed. The container structure according to one aspect of the present disclosure may include a container body having an internal space formed therein and one end open; a stopper coupled to the container body so as to close the open end of the container body; and an elastic thin film dividing the internal space of the container body into a first space in which a fluid is stored and a second space separated from the first space.

### CROSS-REFERENCE TO RELATED APPLICATION

This application claims priority to and the benefit of Korean Patent Application No. 10-2023-0135920, filed on Oct. 12, 2023, the disclosure of which is incorporated herein by reference in its entirety.

### TECHNICAL FIELD

The present disclosure relates to a container structure and a fluid transfer device including the same, and more specifically to a container structure which is configured to transfer a fluid without power and regardless of gravity, and a fluid transfer device including the same.

### RELATED ART

In general, gravity or an actuator such as a pump is used to discharge a fluid stored in a container to the outside. This content is also applied to microfluidic technology.

Microfluidic technology refers to a technique that moves a small amount of fluid through a very narrow channel (tens of micrometers to hundreds of micrometers in width).

With regard to conventional microfluidic technology, syringe pumps or hydraulic pumps were conventionally used to inject samples and control sample flow. These pumps are large in size and require power, and thus, they have problems in that portability and convenience are not good.

### SUMMARY

The present disclosure has been devised to solve the above problems, and an object of the present disclosure is to provide a container structure which is capable of transferring a fluid without power and regardless of gravity, and a fluid transfer device including the same.

According to an aspect of the present disclosure, provided is a container structure, including a container body having an internal space formed therein and one end open; a stopper coupled to the container body so as to close the open end of the container body; and an elastic thin film configured to divide the internal space of the container body into a first space in which a fluid is stored and a second space separated from the first space.

In this case, a fixed end of the elastic thin film may be fixed to at least one of an inner side surface of the open end of the container body and an inner side surface of the stopper facing the internal space.

In this case, the stopper may include a stopper body coupled to an open end of the container body and having a ring shape with an open center; and a septum disposed in a hollow of the stopper body and coupled to the stopper body.

Meanwhile, the second space may be a closed space.

Meanwhile, a plurality of through-holes may be formed on the container body such that the second space is connected to outside air.

In this case, in an initial state, all of the plurality of through-holes may be closed by the elastic thin film, and in a fluid discharge state where the fluid stored in the first space is discharged to the outside due to a contraction force of the elastic thin film, the elastic thin film may contract, and the plurality of through-holes may be sequentially opened.

In the fluid discharge state, the size, number and location of the plurality of through-holes may be determined such that the discharge speed of the fluid has a set speed change.

According to another aspect of the present disclosure, provided is a fluid transfer device, including a base member having a flow path formed therein through which the fluid moves; and a hollow needle formed to protrude from one side of the base member, connected to the flow path, and penetrating a stopper of the container structure.

In this case, one end of the flow path may be connected to the hollow needle.

Meanwhile, the fluid transfer device may further include a hollow recovery needle protrudingly formed on the other side of the base member, and connected to the flow path; and a recovery container having a recovery space formed through which the recovery needle penetrates and in which the fluid that is discharged through the needle from the container structure and moves along the flow path is recovered.

In this case, the other end of the flow path may be connected to the hollow recovery needle.

Meanwhile, in some areas of the flow path, an attachment member may be disposed, to which a specific component contained in the fluid is attached.

In this case, in some areas of the flow path, a large-area portion with a larger cross-sectional area than other areas may be formed, and the attachment member may be disposed in the large-area portion.

According to one aspect of the present disclosure, the container structure can continuously and effectively discharge a fluid stored in the container structure without power, regardless of the presence or absence of gravity or the direction of gravity acting on the fluid, by using a contraction force of the elastic thin film as the power to discharge the fluid stored in the container structure.

According to another aspect of the present disclosure, the fluid transfer device can continuously and effectively discharge and transfer a fluid stored in the container structure without power, regardless of the presence or absence of gravity or the direction of gravity acting on the fluid, by using a contraction force of the elastic thin film of the container structure as the power to transfer the fluid stored in the container structure along the flow path of a base member.

The effects of the present disclosure are not limited to the above effects, and should be understood to include all effects that can be inferred from the constitutions of the invention described in the detailed description or claims of the present disclosure.

### BRIEF DESCRIPTION OF THE DRAWINGS

FIG. 1 is a perspective view of a container structure according to an embodiment of the present disclosure.

FIG. 2 is a view showing the cross-section of a container structure according to an embodiment of the present disclosure.

FIG. 3 is a cross-sectional view of a stopper of a container structure according to an embodiment of the present disclosure.

FIG. 4 is a view showing a stopper according to another embodiment of the present disclosure.

FIG. 5 and FIG. 6 are views for explaining one usage case of a container structure according to an embodiment of the present disclosure.

FIG. 7 is a view showing the cross-section of a container structure according to another embodiment of the present disclosure.

FIG. 8 is a view showing a state in which the elastic thin film of the container structure illustrated in FIG. 7 is contracted.

FIG. 9 is a view showing a state in which a fluid transfer device according to an embodiment of the present disclosure is partially separated.

FIG. 10 is a view showing the coupled state of a fluid transfer device according to an embodiment of the present disclosure.

FIG. 11 to FIG. 13 are views for explaining the fluid transfer mechanism of a fluid transfer device according to an embodiment of the present disclosure.

FIG. 14 is a view for explaining one usage case of a fluid transfer device according to an embodiment of the present disclosure.

### DETAILED DESCRIPTION OF THE EMBODIMENTS

Hereinafter, with reference to the attached drawings, the embodiments of the present disclosure will be described in detail so that those skilled in the art can easily practice the present disclosure. The present disclosure may be implemented in many different forms and is not limited to the embodiments described herein. In order to clearly explain the present disclosure, parts that are not related to the description have been omitted in the drawings, and the same or similar components are assigned the same reference numerals throughout the specification.

The words and terms used in the present specification and claims are not to be construed as limited in their usual or dictionary meanings, but according to the principle that the inventor can define terms and concepts in order to explain his or her invention in the best way, they must be interpreted with meaning and concepts consistent with technical ideas.

Therefore, the embodiments described in the present specification and the configuration illustrated in the drawings correspond to a preferred embodiment of the present disclosure, and do not represent the entire technical idea of the present disclosure, and thus, the corresponding configuration may have various equivalents and variations that may replace the same at the time of filing of the present disclosure.

It should be understood that the terms “include” or “have”, when used in the present specification, are intended to describe the presence of stated features, integers, steps, operations, elements, components and/or a combination thereof, but not preclude the possibility of the presence or addition of one or more other features, integers, steps, operations, elements, components or a combination thereof.

The presence of an element in/on “front”, “rear”, “upper or above or top” or “lower or below or bottom” of another element includes not only being disposed in/on “front”, “rear”, “upper or above or top” or “lower or below or bottom” directly in contact with other elements, but also cases in which another element being disposed in the middle, unless otherwise specified. In addition, unless otherwise specified, that an element is “connected” to another element includes not only direct connection to each other but also indirect connection to each other.

Hereinafter, the container structure according to an embodiment of the present disclosure will be described with reference to the drawings.

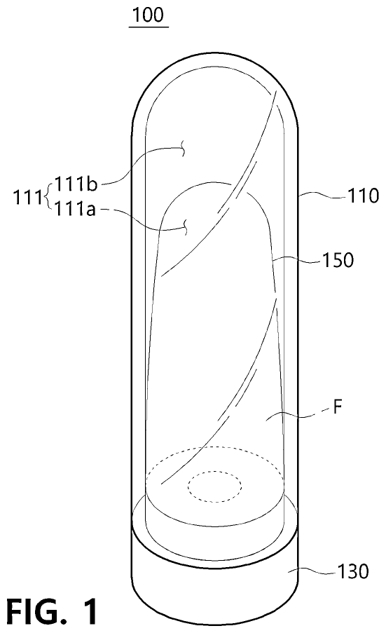

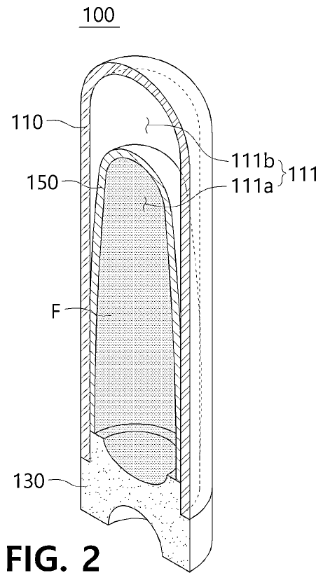

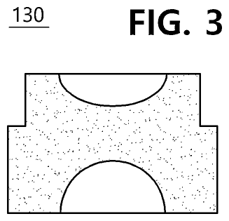

FIG. 1 is a perspective view of a container structure according to an embodiment of the present disclosure, FIG. 2 is a view showing the cross-section of a container structure according to an embodiment of the present disclosure, and FIG. 3 is a cross-sectional view of a stopper of a container structure according to an embodiment of the present disclosure.

Referring to FIGS. 1 to 3, the container structure 100 according to the present embodiment includes a container body 110, a stopper and an elastic thin film 150.

An internal space 111 is formed in the container body 110. The container body 110 has a shape in which one end is open. For example, the container body 110 may have a cylinder shape in which one end is open, but is not limited thereto.

The container body 110 may be made of glass or plastic, but is not limited thereto.

The stopper 130 is coupled to the container body 110 so as to close the open end of the container body 110.

In the present embodiment, the stopper 130 may be configured to have a single body as shown in FIG. 3.

The stopper 130 may be inserted and penetrated through a hollow needle (not illustrated). The fluid (F) stored inside the container body 110 may be discharged to the outside through the needle (not illustrated) that penetrates the stopper 130 and is introduced into the interior of the container body 110.

For example, the stopper 130 may be made of any one material among rubber, silicone and cork. If the stopper 130 is made of the above material, even if the needle (not illustrated) that penetrates the stopper 130 is removed from the stopper 130, the penetration portion of the stopper 130 may be resealed by the dense tissue.

In this case, even if the work of injecting a fluid (F) into the interior of the container structure 100 or discharging a fluid (F) stored in the container structure 100 to the outside through a needle (not illustrated) penetrating the stopper 130 is repeated, the portion penetrated by the needle (not illustrated) may be sealed again such that the container structure 100 can be repeatedly used.

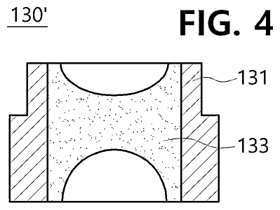

Meanwhile, the stopper 130′ according to another embodiment may be configured to include a stopper body 131 and a septum 133 as shown in FIG. 4. For reference, FIG. 4 is a drawing showing a stopper according to another embodiment of the present disclosure.

Referring to FIG. 4, the stopper body 131 may be coupled to an open end of the container body 110 of FIG. 1. The stopper body 131 may have a ring shape with an open center. For example, the stopper body 131 may have a metal or plastic material, but is not limited thereto.

The septum 133 is disposed in the central opening of the stopper body 131 and is coupled to the stopper body 131.

The septum 133 may be inserted and penetrated through a hollow needle (not illustrated). For example, the septum 133 may be made of any one of rubber, silicone and cork.

Referring to FIGS. 1 and 2, the elastic thin film 150 divides the internal space 111 of the container body 110 into a first space 111a and a second space 111b. The first space 111a is a space where the fluid (F) is stored, and the second space 111b is a space which is separated from the first space 111a. The first space 111a is formed to be in contact with the stopper 130.

For example, if the amount of fluid (F) stored in the first space 111a is relatively large, the elastic thin film 150 is stretched relatively large in the internal space 111 of the container body 110. In this case, the volume of the first space 111a increases compared to a case where the amount of fluid (F) stored in the first space 111a is small.

In other words, if the fluid (F) stored in the first space 111a is relatively small, the elastic thin film 150 contracts relatively much inside the container body 110. In this case, the volume of the first space 111a decreases compared to a case where the fluid (F) stored in the first space 111a is large.

The fluid (F) stored in the first space 111a may be a liquid or a gas.

The elastic thin film 150 may be made of rubber or latex. However, this is only an example, and the elastic thin film 150 may be made of a known material having elasticity.

In the present embodiment, the contraction force of the elastic thin film 150 becomes the driving force for discharging a fluid (F) stored in the first space 111a through the hollow needle (not illustrated) penetrating the stopper 130.

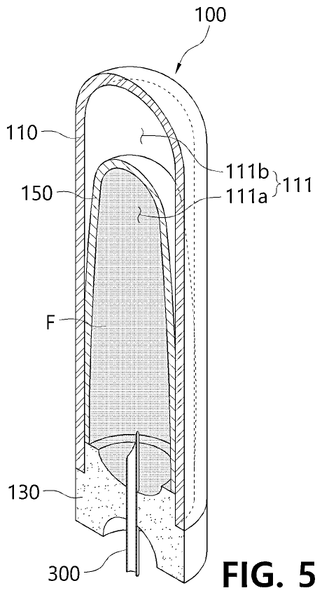

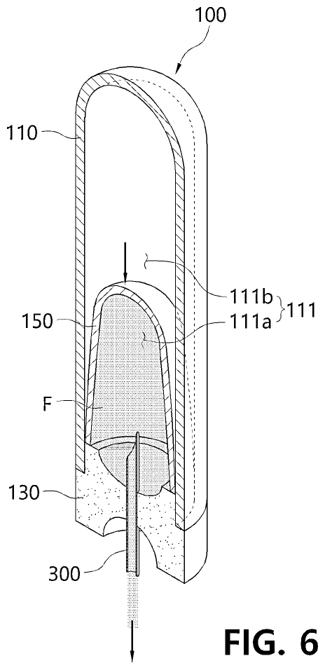

FIG. 5 and FIG. 6 are views for explaining one usage case of a container structure according to an embodiment of the present disclosure. Hereinafter, the mechanism for discharging a fluid (F) from the container structure 100 will be explained with reference to FIGS. 5 and 6.

Referring to FIG. 5, a fluid (F) is stored in a first space 111a of a container structure 100. A hollow needle 300 penetrates a stopper, and an end of the needle 300 is located inside the container body 110. In this case, the first space 111a is connected to the outside.

Referring to FIG. 6, when the first space 111a and the outside are connected through a hollow needle 300 penetrating a stopper, the elastic thin film 150 contracts, and the fluid (F) stored in the first space 111a is discharged to the outside through the needle 300. In this case, the contraction force of the elastic thin film 150 becomes the driving force for discharging the fluid (F) stored in the first space 111a to the outside through the hollow needle 300.

As discussed above, when the hollow needle 300 penetrates the container structure 100, the contraction force of the elastic thin film 150 acts as the driving force for discharging the fluid (F) stored in the container structure 100, and thus, the fluid (F) stored in the container structure 100 may be continuously and effectively discharged without power regardless of the presence or absence of gravity or the direction of gravity acting on the fluid (F).

Referring to FIGS. 1 and 2, the fixed end of the elastic thin film 150 may be fixed to at least one of an inner side surface of the open end of the container body 110 and an inner side surface of the stopper facing the inner space 111 of the container body 110.

In this case, the elastic thin film 150 may contract to the maximum extent on the inner side of one end of the container body 110 where the fixed end is located or the inner side of the stopper 130 in a situation where the fluid (F) is discharged such that the fluid (F) stored in the first space 111a can be discharged to the maximum extent.

In the present embodiment, the second space 111b, which is one of the internal spaces 111 of the container body 110, may be a sealed space. In this case, the pressure (or air pressure) of the second space 111b, which is a sealed space, may be lowered during the process of contracting the elastic thin film 150.

This decrease in air pressure of the second space 111b may weaken the contraction force of the elastic thin film 150 that is being stretched. In order to solve this problem, the elastic thin film 150 may be manufactured and installed such that the contraction force that can smoothly discharge the fluid (F) is provided by considering a pressure decrease of the second space 111b.

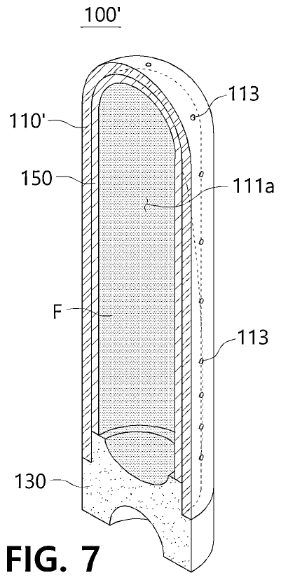

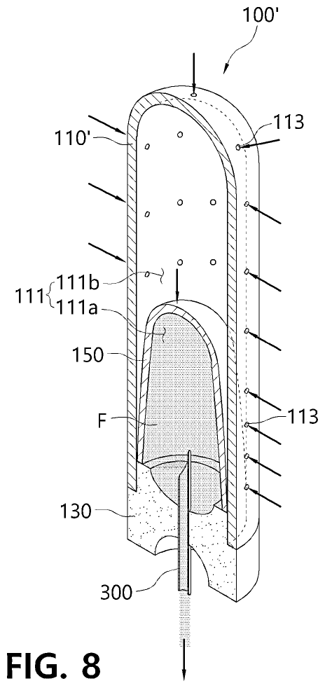

FIG. 7 is a view showing the cross-section of a container structure according to another embodiment of the present disclosure, and FIG. 8 is a view showing a state in which the elastic thin film of the container structure illustrated in FIG. 7 is contracted.

Referring to FIGS. 7 and 8, the container structure 100′ according to the present embodiment may be configured to include a container body 110′, a stopper 130 and an elastic thin film 150.

The container structure 100′ according to the present embodiment is different from the container structure 100 according to the previous embodiment in the container body 110′.

A plurality of through-holes 113 are formed on the container body 110′ according to the present embodiment such that the second space 111b is connected to outside air.

Referring to FIG. 7, in an initial state, the plurality of through-holes 113 may all be closed by the elastic thin film 150. Herein, the initial state means a state in which the fluid (F) stored in the first space 111a is not discharged to the outside from the first space 111a.

For example, as shown in FIG. 7, in the initial state, the first space 111a may be filled with the fluid (F), and the elastic thin film 150 may be stretched to the maximum inside the container body 110′. In this case, the elastic thin film 150 may close all of the plurality of through-holes 113 formed on the container body 110′.

As another example, although not illustrated, in the initial state, the elastic thin film may not be stretched to the maximum inside the container body, unlike FIG. 7, depending on the amount of a fluid filled in the first space. Even in this case, the plurality of through-holes formed in the container body may be distributed such that the elastic thin film closes all of the plurality of through-holes, unlike FIG. 7.

Referring to FIG. 8, in a fluid discharge state, the elastic thin film 150 may contract, and the plurality of through-holes 113 may be sequentially opened. Herein, the fluid discharge state means a state in which the fluid (F) stored in the first space 111a is discharged to the outside due to the contraction force of the elastic thin film 130. For example, the fluid discharge state may be generated by a hollow needle 300 penetrating the stopper 130.

When the hollow needle 300 penetrates the stopper 300, the elastic thin film 150 contracts, and the fluid (F) in the first space 111a may be discharged to the outside.

In this case, the plurality of through-holes 113 may be sequentially opened due to the contraction of the elastic thin film 150, and outside air may gradually flow into the second space 111b through the through-holes 113.

When outside air is introduced into the second space 111b, the pressure drop in the second space 111b is prevented, and accordingly, the contraction force of the elastic thin film 150 may be prevented from weakening, thereby enabling smooth discharge of the fluid (F).

Meanwhile, with respect to the number and position of the through-holes 113, the size, number and location of the through-holes 113 may be determined such that the discharge speed of the fluid (F) has a set speed change in the fluid discharge state.

For example, in the case where the fluid (F) is discharged in a situation where the through-holes are not formed in the container body 110 as shown in FIG. 6, the internal pressure of the sealed second space 111b decreases as the elastic thin film 150 contracts, which can reduce the contraction force of the elastic thin film 150. In this case, the discharge speed of the fluid discharged from the first space 111a may decrease rapidly.

However, in a situation where a through-hole 113 is formed in the container body 110′ as shown in FIG. 8, when the fluid (F) is discharged, as the elastic thin film 150 contracts, outside air flows into the second space 111b, and the pressure drop in the second space 111b may slow down.

In this case, the pressure drop speed of the second space 111b may vary depending on the amount of outside air flowing into the second space 111b through the through-hole 113. In addition, as the pressure drop speed of the second space 111b varies, the contraction force weakening speed of the elastic thin film 150 may vary. In addition, as the contraction force weakening speed of the elastic thin film 150 varies, the discharge speed of the fluid discharged from the first space 111a may vary.

If the size, number and location of the through-holes 113 formed in the container body 110′ are changed, the amount of outside air flowing into the second space 111b through the through-holes 113 in the fluid discharge state may be changed, and ultimately, the discharge speed of the fluid discharged from the first space 111a may be changed.

The container structure 110′ according to the present embodiment may be manufactured by determining the size, number and location of the through-holes 113 such that the discharge speed of the fluid (F) in the fluid discharge state has a set speed change.

For example, a plurality of through-holes 113 formed on the container body 110′ may be distributed such that the density of the through-holes 113 increases as they get closer to the stopper 130, as shown in FIGS. 7 and 8.

In this case, as the elastic thin film 150 contracts in the fluid discharge state, the number of through-holes 113 that are opened may significantly increase, and the amount of outside air flowing into the second space 111b through the opened through-holes 113 may significantly increase.

In addition, if outside air is significantly introduced into the second space 111b through the through-holes 113, the pressure drop speed of the second space 111b may significantly decrease. In addition, if the pressure drop speed of the second space 111b is significantly reduced, the contraction force weakening speed of the elastic thin film 150 may significantly decrease. In addition, if the contraction force weakening speed of the elastic thin film 150 is significantly reduced, the discharge speed of the fluid discharged from the first space 111a may be significantly reduced.

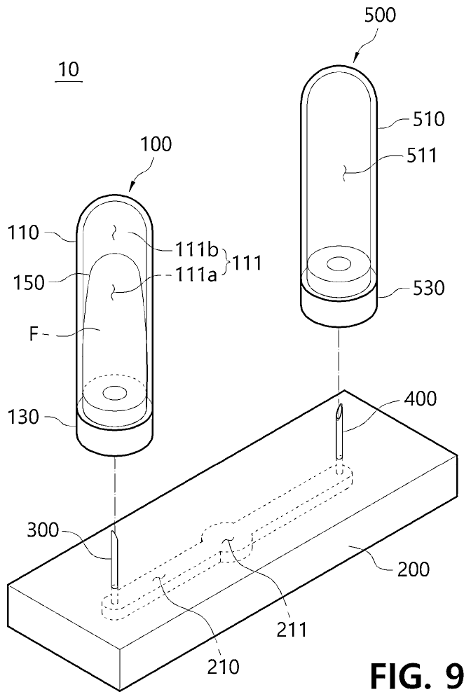

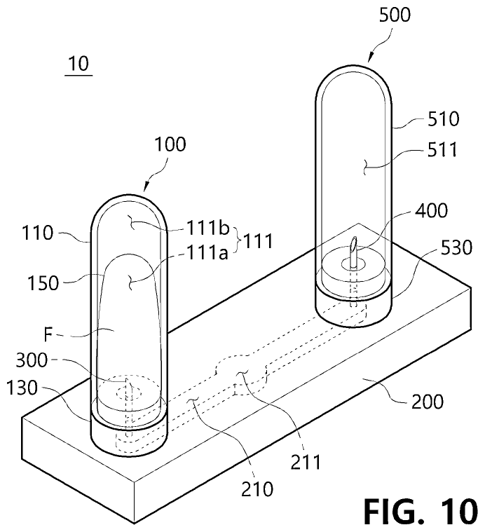

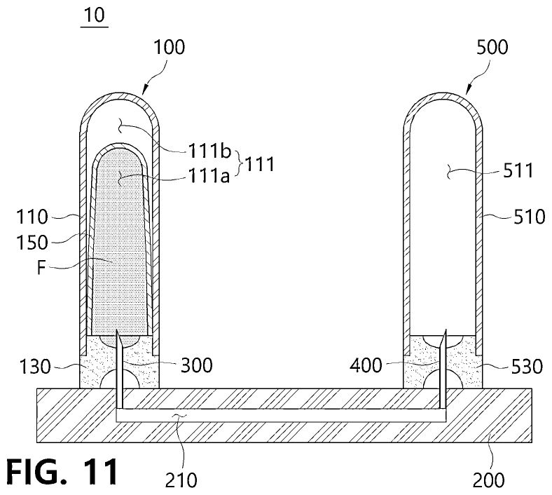

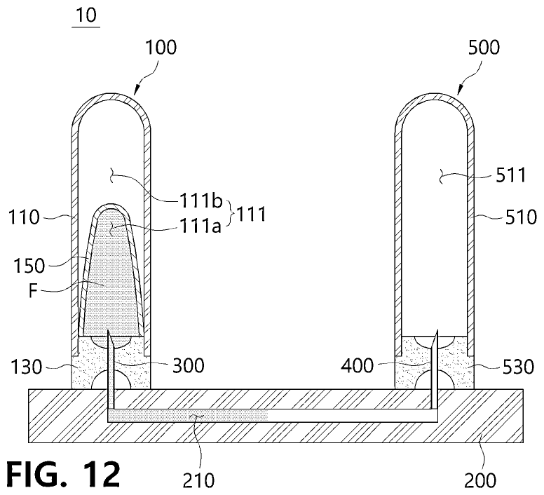

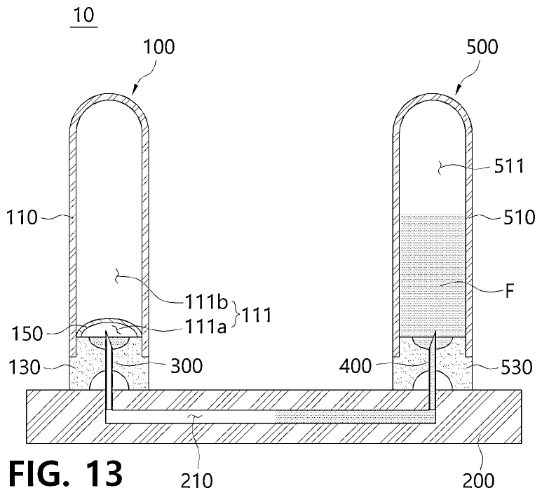

FIG. 9 is a view showing a state in which a fluid transfer device according to an embodiment of the present disclosure is partially separated, FIG. 10 is a view showing the coupled state of a fluid transfer device according to an embodiment of the present disclosure, and FIG. 11 to FIG. 13 are views for explaining the fluid transfer mechanism of a fluid transfer device according to an embodiment of the present disclosure.

Referring to FIGS. 9 and 10, the fluid transfer device 10 according to the present embodiment may include a container structure 100, a base member 200 and a needle 300, and may continuously and effectively discharge and transfer a fluid (F) stored in the container structure 100 regardless of the presence or absence of gravity or regardless of the direction of gravity acting on the fluid (F) and without power.

More specifically, the fluid (F) is stored in the container structure 100. The container structure 100 illustrated in FIGS. 9 and 10 is the same as the structure described above based on FIGS. 1 to 3, and the description thereof will be omitted. However, it is certain that the container structure 100′ illustrated in FIG. 7 may be used in the fluid transfer device according to the present embodiment.

The base member 200 has a flow path 210 formed therein through which the fluid (F) moves.

The base member 200 may have a structure that is elongated in one direction. The flow path 210 may be formed to extend from one side of the longitudinal direction of the base member 200 to the other side. A large-area portion 211 having a larger cross-sectional area than other areas may be formed in the central region of the flow path 210.

An attachment member (not illustrated) to which a specific component contained in the fluid (F) is attached may be disposed in the large-area portion 211. This will be described below.

The needle 300 is formed protrudingly on one side of the base member 200.

The needle 300 is provided in a hollow shape. For example, the needle 300 has a hollow formed inside in the protruding longitudinal direction in which the fluid can move. The hollow is connected to the flow path 210 of the base member 200. In this case, one end of the flow path 210 is connected to the needle 300.

The needle 300 penetrates the stopper 130 of the container structure 100. The penetration end of the needle 300 that penetrates the stopper 130 may be located in the first space 111a of the container structure 100 in which the fluid (F) is stored.

When the container structure 100 is inserted into the needle 300, the fluid (F) stored in the first space 111a may be discharged from the container structure 100 through the needle 300 and moved along the flow path 210.

In this process, the contraction force of the elastic thin film 150 of the container structure 100 may be the driving force to discharge the liquid such that the liquid can be transferred without power without a separate pump.

Furthermore, even when the container structure 100 is inserted into the needle 300 and the container structure 100 takes a position in which the stopper is above and the container body 110 is below, the liquid stored in the container structure 100 may be discharged by the contraction force of the elastic thin film 150 regardless of gravity.

The fluid transfer device 10 according to the present embodiment may further include a recovery needle 400 and a recovery container 500.

The recovery needle 400 is formed protrudingly on the other side of the base member 200.

The recovery needle 400 is provided in a hollow shape. For example, the recovery needle 400 has a hollow formed inside in the protruding longitudinal direction in which the fluid can move. The hollow is connected to the flow path 210 of the base member 200. In this case, the other end of the flow path 210 is connected to the recovery needle 400.

The recovery needle 400 penetrates the recovery container 500.

The recovery container 500 is configured to recover the fluid (F) stored in the container structure 100 is recovered, and a recovery space 511 is formed in the recovery container 500.

The recovery container 500 may be configured to include a recovery container body 510 and a recovery stopper 530.

The recovery container body 510 provides a recovery space 511. The recovery container body 510 has a shape in which one end is open.

For example, the recovery container body 510 may have a cylinder shape in which one end is open, but is not limited thereto.

The recovery container body 510 may be made of glass or plastic, but is not limited thereto.

The recovery stopper 530 is coupled to the recovery container body 510 so as to close the open end of the recovery container body 510. The recovery stopper 530 is coupled to the recovery container body 510 so as to close the open end of the recovery container body 510. When the recovery stopper 530 is coupled to the recovery container body 510, the recovery space 511 formed inside the recovery container 500 is sealed.

The recovery stopper 530 according to the present embodiment may have a single body, like the stopper illustrated in FIG. 3. Alternatively, although not illustrated, in another embodiment, the recovery stopper may be configured to include a recovery stopper body and a recovery septum as shown in FIG. 4.

Referring to FIGS. 11 to 13, when the container structure 100 and the recovery container 500 are inserted into the needle 300 and the recovery needle 400, respectively, the fluid (F) stored in the first space 111a may be discharged from the container structure 100 through the needle 300, moved along the flow path 210, and introduced into the recovery container 500 through the recovery needle 400 to be recovered.

In this process, the contraction force of the elastic thin film 150 of the container structure 100 may be the driving force to transfer the liquid in the container structure 100 to the recovery container 500, and thus, that the liquid may be transferred without power without a separate pump.

Furthermore, while the container structure 100 and the recovery container 500 are inserted into the needle 300 and the recovery needle 400, respectively, regardless of the position (e.g., inverted position) of the base member 200, the liquid stored in the container structure 100 may be transferred to the recovery container 500 by the contraction force of the elastic thin film 150 regardless of gravity.

According to the present embodiment, the container structure 100 and the recovery container 500 may be provided such that the contraction force provided by the elastic thin film 150 during the liquid transfer process is greater than the pressure of the recovery space 511 in the recovery container 500. In this case, the liquid transfer from the container structure 100 to the recovery container 500 may be performed continuously and smoothly.

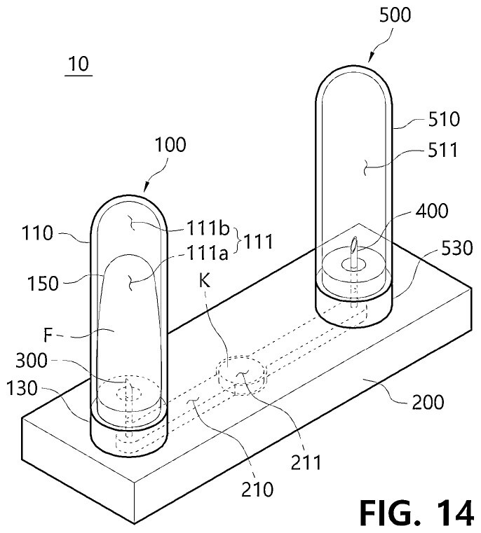

FIG. 14 is a view for explaining one usage case of a fluid transfer device according to an embodiment of the present disclosure.

Hereinafter, with reference to FIG. 14, one usage example of the fluid transfer device 10 according to an embodiment of the present disclosure will be described.

The fluid transfer device 10 according to the present embodiment may be utilized as a device for extracting nucleic acid contained in a liquid. In this case, the fluid (F) stored in the container structure 100 is a liquid, and the liquid contains nucleic acid.

An attachment member (K) to which nucleic acid is attached may be disposed in a large-area portion 211 of a flow path 210 formed in a base member 200. Since the large-area portion 211 has a larger cross-sectional area than other parts of the flow path 210, a relatively large attachment member (K) may be disposed, and accordingly, the attachment efficiency of nucleic acid may be increased.

When the container structure 100 and the recovery container 500 are respectively inserted into the needle 300 and the recovery needle 400, the liquid containing the nucleic acid stored in the first space 111a is discharged from the container structure 100 through the needle 300, moves along the flow path 210, and flows into the recovery space 511 of the recovery container 500 through the recovery needle 400 and may be recovered.

In this process, the liquid moving along the flow path 210 passes the attachment member (K). In this case, the nucleic acid contained in the liquid is attached to the attachment member (K), and only the liquid from which the nucleic acid has been removed may be recovered into the recovery container 500.

However, the fluid transfer device 10 according to an embodiment of the present disclosure may be used not only for the purpose of extracting nucleic acid, but may also be used in various ways in the field of microfluidic technology.

Although the embodiments of the present disclosure have been described above, the spirit of the present disclosure is not limited to the embodiments presented in the present specification, and those skilled in the art who understand the spirit of the present disclosure may easily suggest other embodiments by changing, modifying, deleting or adding components within the scope of the same spirit, but this will also fall within the scope of the present disclosure.

What is claimed is:

1. A container structure, comprising:
a container body having an internal space formed therein and one end open;
a stopper coupled to the container body so as to close the open end of the container body; and
an elastic thin film configured to divide the internal space of the container body into a first space in which a fluid is stored and a second space separated from the first space.

2. The container structure of claim 1, wherein a fixed end of the elastic thin film is fixed to at least one of an inner side surface of the open end of the container body and an inner side surface of the stopper facing the internal space.

3. The container structure of claim 1, wherein the stopper comprises:
a stopper body coupled to an open end of the container body and having a ring shape with an open center; and
a septum disposed in a hollow of the stopper body and coupled to the stopper body.

4. The container structure of claim 1, wherein the second space is a closed space.

5. The container structure of claim 1, wherein a plurality of through-holes are formed on the container body such that the second space is connected to outside air.

6. The container structure of claim 5, wherein in an initial state, all of the plurality of through-holes are closed by the elastic thin film, and wherein in a fluid discharge state where the fluid stored in the first space is discharged to the outside due to a contraction force of the elastic thin film, the elastic thin film contracts, and the plurality of through-holes are sequentially opened.

7. The container structure of claim 6, wherein in the fluid discharge state, the size, number and location of the plurality of through-holes are determined such that the discharge speed of the fluid has a set speed change.

8. A fluid transfer device, comprising:
the container structure according to claim 1;
a base member having a flow path formed therein through which the fluid moves; and
a hollow needle formed to protrude from one side of the base member, connected to the flow path, and penetrating a stopper of the container structure.

9. The fluid transfer device of claim 8, wherein one end of the flow path is connected to the hollow needle.

10. The fluid transfer device of claim 8, further comprising:
a hollow recovery needle protrudingly formed on the other side of the base member, and connected to the flow path; and
a recovery container having a recovery space formed through which the recovery needle penetrates and in which the fluid that is discharged through the needle from the container structure and moves along the flow path is recovered.

11. The fluid transfer device of claim 10, wherein the other end of the flow path is connected to the hollow recovery needle.

12. The fluid transfer device of claim 8, wherein in some areas of the flow path, an attachment member is disposed, to which a specific component contained in the fluid is attached.

13. The fluid transfer device of claim 12, wherein in some areas of the flow path, a large-area portion with a larger cross-sectional area than other areas is formed, and the attachment member is disposed in the large-area portion.
